(19) United States
(12) Patent Application Publication
(10) Pub. No.: US 2006/0066220 A1
(43) Pub. Date: Mar. 30, 2006

(54) Reduction or elimination of color change with viewing angle for microcavity devices

(76) Inventors: Vi-En Choong, San Jose, CA (US); Franky So, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/951,514

(22) Filed: Sep. 27, 2004

(51) Int. Cl. H05B 33/02; H05B 33/00

(52) U.S. Cl. 313/501; 313/504; 313/503; 313/506; 313/500

(57) ABSTRACT

In an embodiment of the invention, a microcavity OLED device that minimizes or eliminates color change at different viewing angles is fabricated. This OLED device includes a multi-layer mirror on a substrate, and each of the layers are comprised of a non-absorbing material. The OLED device also includes a first electrode on the multi-layered first mirror, and the first electrode is substantially transparent. An emissive layer is on the first electrode. A second electrode is on the emissive layer, and the second electrode is substantially reflective and functions as a mirror. The multi-layer mirror and the second electrode form a microcavity that amplifies a particular wavelength that is in resonance with an optical length of the microcavity. The emissive layer is comprised of a material that has an emission spectrum with no luminance components with significant intensity at wavelengths shorter than a wavelength at which a color change begins to occur.

### BACKGROUND OF THE INVENTION

An organic light emitting diode (“OLED”) display typically includes, in sequence: (1) a substrate made of, for example, glass; (2) a transparent anode (e.g., the anode can be comprised of indium tin oxide (“ITO”)); (3) a hole transporting layer (“HTL”); (4) an electron transporting and light emitting layer (“emissive layer”); and (5) a cathode. When a forward bias voltage is applied, holes are injected from the anode into the HTL, and the electrons are injected from the cathode into the emissive layer. Both types of carriers are then transported towards the opposite electrode and allowed to recombine with each other in the display, the location of which is called the recombination zone.

Due to the refractive indices of the different layers, and the glass substrate, only a small percentage of the light emitted by the emissive layer is output from the display. One technique to increase the percentage of light output from the display is to use a resonant OLED structure, which is an OLED device that makes use of a microcavity. The mirrors needed to form the microcavity are provided by the metal cathode and a multi-layer stack of non-absorbing materials (e.g., a distributed Bragg reflector (“DBR”) stack). The resonant OLED display achieves greater percentage of light output and also greater light intensity thru constructive interference of wavelengths that are in resonance with the microcavity. The wavelength of the light output by the display is determined, in part, by the optical length of the microcavity, which can be manipulated by, for example, changing the thickness of the layers that make up the microcavity.

Unfortunately, microcavity devices have an emission spectrum that undesirably varies as a function of viewing angle from the display. That is, a blue shift in the emitted wavelength (i.e., a shift towards shorter wavelengths) occurs with an increase in the viewing angle from the normal to the emitting surface of the display. In microcavity devices, the distance between standing wave nodes of incident and reflected waves decrease with an increase in viewing angle. Thus, to match the characteristic dimension of the cavity requires shorter wavelengths. Accordingly, the peak emitted wavelength emitted by the microcavity may decrease by about 20 to 45 nm with a 40° shift in viewing angle from the normal to the emitting surface of the display (i.e., the normal to the emitting surface of the display means that the emitted light is viewed at 0° viewing angle). This blue shift limits the use of the resonant OLED structure in a number of important applications, such as displays and traffic lights, where visual perception and impressions are important.

FIG. 1 shows the dependence of color on the viewing angle when a microcavity is used in the OLED display. The emission spectrums shown in FIG. 1 were produced by a microcavity that was designed to enhance 540 nm light. From a viewing angle that is normal to the emitting surface of the display (i.e., viewing angle of 0°), the peak emitted wavelength is at 540 nm. However, at 20 viewing angle, the peak emitted wavelength has blue shifted by about 15 nm. At 40° viewing angle, the blue shift is worse—the peak emitted wavelength has blue shifted by about 30 nm from the peak emitted wavelength at the 0° viewing angle.

FIGS. 2a-d show simulated emission spectrums at various viewing angles for OLED displays with and without a microcavity where the emissive layer is made of a green emitting material such as, for example, green emitting LUMATION polymers produced by Dow Chemical, Midland, Mich. In FIG. 2a, the OLED with the microcavity has a peak emitted wavelength of about 540 nm at the viewing angle of 0°. In FIG. 2b, at the viewing angle of 21.06°, the OLED with the microcavity has a peak emitted wavelength of about 525 nm—a blue shift of about 15 nm from the peak emitted wavelength at the 0° viewing angle. In FIG. 2c, at the viewing angle of 30.35°, the OLED with the microcavity has a peak emitted wavelength of about 515 nm—a blue shift of about 25 nm from the peak emitted wavelength at the 0° viewing angle. In FIG. 2d, at the viewing angle of 40.34°, the OLED with the microcavity has a peak emitted wavelength of about 500 nm—a blue shift of about 40 nm from the peak emitted wavelength at the 0° viewing angle. At 500 nm, the emitted color changes to a blue-green color. At the viewing angle of 40.34°, the color output by the display is the blue-green color. As shown in FIGS. 2a-d, the emission spectrum for the OLED display without the microcavity is not blue shifted at different viewing angles.

The blue-shifting results in a perceived color change of the light output by the OLED display and this color change is unacceptable. Techniques to reduce or avoid this unwanted effect include the use of color filters with a cut-off at wavelengths where a color change begins to occur; e.g., for FIG. 1, the cut-off can occur at about 530 nm. Use of dichroic filters or other filtering techniques have also been proposed. These filtering techniques do work, but due to the transmissive efficiency of filters in general, a large percentage of the OLED emission is lost through the filter. This loss can be as high as 90%.

Because of the advantages of using a microcavity such as increased light intensity, increased percentage of light output, and improved color purity, it is desirable to have an OLED device that uses a microcavity but which minimizes or eliminates the color change due to a change in the viewing angle.

### SUMMARY

An embodiment of this invention pertains to a microcavity OLED device that minimizes or eliminates color change at different viewing angles. The device includes a multi-layer mirror on a substrate, where the multi-layer mirror is comprised of multiple layers and each of the layers is comprised of a non-absorbing material. The device also includes the following: a substantially transparent first electrode on the multi-layered mirror, an emissive layer on the first electrode, and a second electrode on the emissive layer, where the second electrode is a mirror. The multi-layer mirror and the second electrode form a microcavity that amplifies a particular wavelength that is in resonance with an optical length of the microcavity. The emissive layer is comprised of a material that has an emission spectrum with no luminance components with significant intensity at wavelengths shorter than a wavelength at which a color change begins to occur. Preferably, the emissive material has an emission spectrum with no luminance components with significant intensity at wavelengths shorter than a resonant optical length of the microcavity at the 0° viewing angle minus 20 nm.

### BRIEF DESCRIPTION OF THE DRAWINGS

FIG. 1 shows the dependence of color on the viewing angle when a microcavity is used in the OLED display.

FIGS. 2a-d shows simulated emission spectrums at various viewing angles for OLED displays with and without a microcavity where the emissive layer is made of green emitting material.

FIG. 3 shows a cross-sectional view of a first embodiment of a microcavity OLED device according to the present invention.

FIG. 4 shows simulated emission spectrums of the emissive layer comprised of green emitting material without a sharp intensity drop-off (“GM”) and a green emitting material with a sharp intensity drop-off (“GM-DROP-OFF”).

FIGS. 5a-d show simulated emission spectrums at various viewing angles for OLED displays with and without a microcavity where the emissive layer is made of the GM-DROP-OFF.

FIG. 6 shows a cross-sectional view of a second embodiment of a microcavity OLED device according to the present invention.

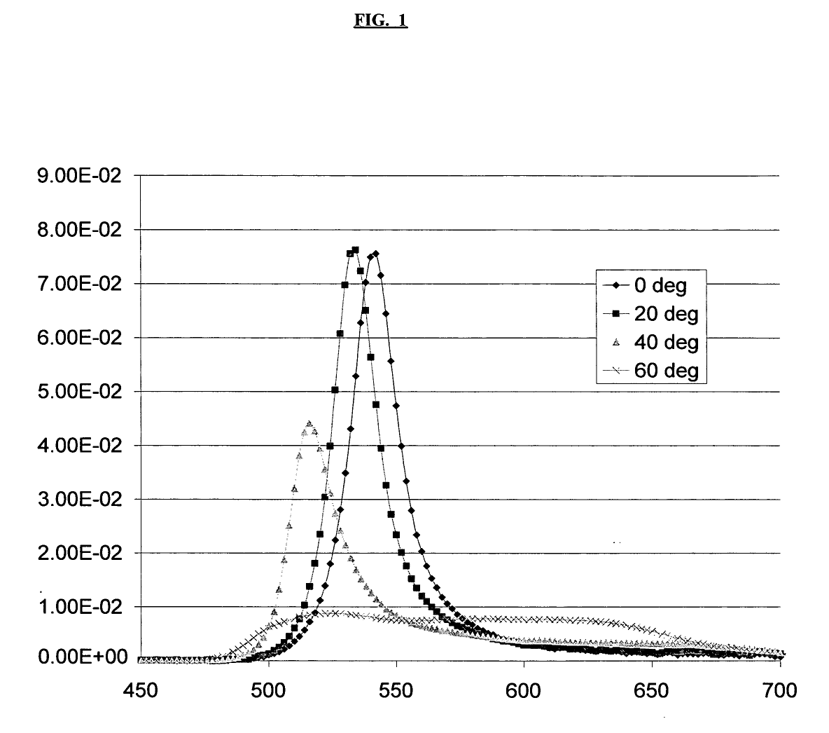

### DETAILED DESCRIPTION

In an embodiment of the invention, a microcavity OLED device that minimizes or eliminates color change at different viewing angles is fabricated. This OLED device includes a multi-layer mirror on a substrate, and each of the layers are comprised of a non-absorbing material. The OLED device also includes a first electrode on the multi-layered first mirror, and the first electrode is substantially transparent. An emissive layer is on the first electrode. A second electrode is on the emissive layer, and the second electrode is substantially reflective and functions as a mirror. Other interlayers may also be present that, for example, improve the efficiency of the device. The multi-layer mirror and the second electrode form a microcavity that amplifies a particular wavelength that is in resonance with an optical length of the microcavity. The emissive layer is comprised of a material that has an emission spectrum with no luminance components with significant intensity at wavelengths shorter than a wavelength at which a color change begins to occur. Preferably, the emissive material has an emission spectrum with no luminance components with significant intensity at wavelengths shorter than a resonant optical length of the microcavity at the 0° viewing angle minus 20 nm. Preferably, the emissive material's emission spectrum has a sharp intensity drop-off near the resonant optical length of the microcavity at the 0° viewing angle minus 20 nm. When using the emissive material with the sharp intensity drop-off, the intensity of the light emitted by the microcavity at the viewing angle of 0° is approximately equal to the intensity of the light emitted at the same viewing angle when using an emissive material that doesn't provide the sharp intensity drop-off assuming that the efficiencies of the materials are the same. In the embodiment of the microcavity OLED device, there is minimal or no blue-shifting of the peak emitted wavelengths at different viewing angles.

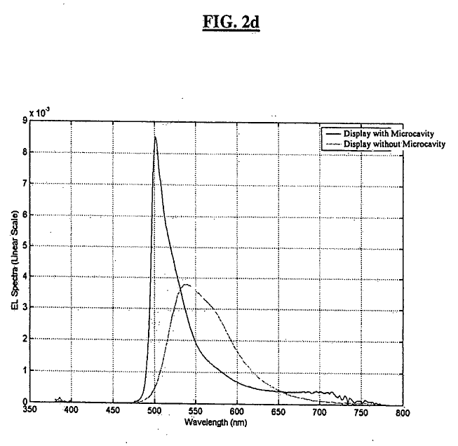

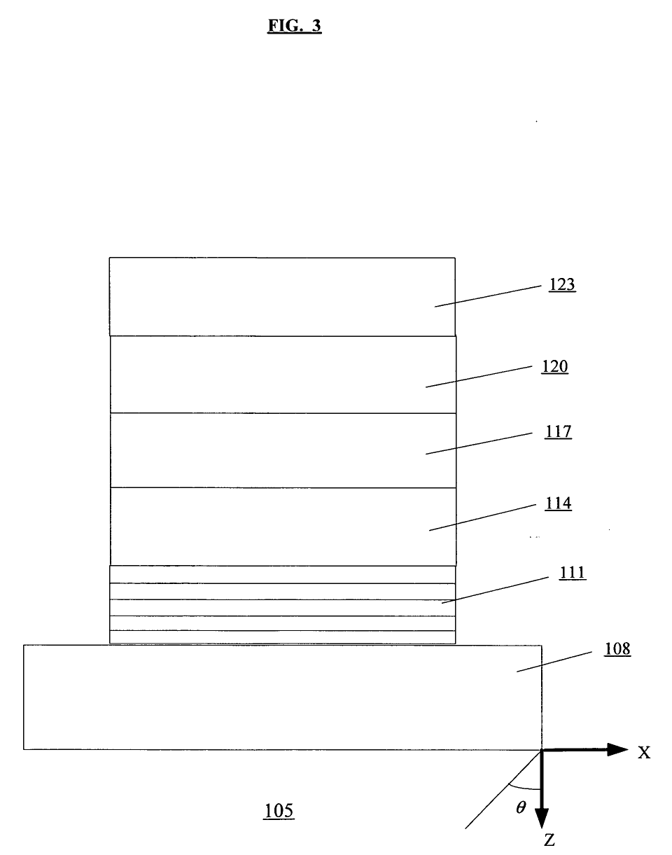

FIG. 3 shows a cross-sectional view of a first embodiment of a microcavity OLED device 105 according to the present invention. The OLED device 105 can be, for example, an OLED display or an OLED light source used for area illumination. In FIG. 3, a multi-layer mirror 111 is on a substrate 108. As used within the specification and the claims, the term “on” includes when there is direct physical contact between the two parts (e.g., layers) and when there is indirect contact between the two parts because they are separated by one or more intervening parts. Each of the layers of the multi-layer mirror 111 is comprised of a non-absorbing material. The substrate 108 is substantially transparent. A first electrode 114 is on the multi-layer mirror 111. The first electrode 114 is substantially transparent. If the first electrode 114 is an anode, then optionally, a HTL 117 is on the first electrode 114 (this configuration is shown in FIG. 3); otherwise, if a second electrode 123 is the anode, then optionally, the HTL 117 is on an emissive layer 120 (this configuration is not shown). The emissive layer 120 is on the HTL 117 if present and if the first electrode is an anode, otherwise, the emissive layer 120 is on the first electrode 114. A second electrode 123 is on the HTL 117 if present and if the second electrode is an anode, otherwise, the second electrode 123 is on the emissive layer 120. The second electrode 123 is substantially reflective and functions as the other mirror.

The multi-layer mirror 111 and the second electrode 123 together form the microcavity. The microcavity amplifies wavelengths that are near the resonance wavelength and suppresses the other wavelengths. The microcavity in the OLED device increases the percentage of light emitted by the emissive layer that is eventually output from the device, reduces the emission bandwidth and thus improves the color purity of the emitted light, and increases the intensity of the emitted light.

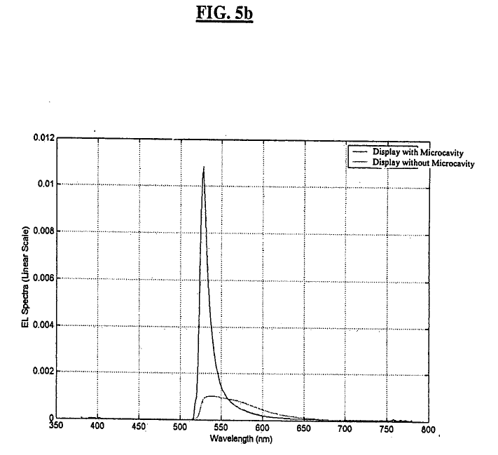

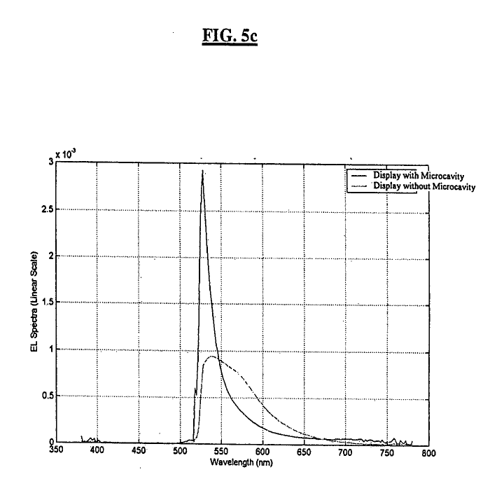

A viewing angle (“θ”) represents an angle from the z-axis; this axis is normal to the substrate 108. Viewing the emitted light from the normal to the emitting surface of the device means that the emitted light is viewed at 0° viewing angle. In the embodiment of the microcavity OLED device, the peak emitted wavelength only slightly becomes shorter with increasing viewing angle (e.g., refer to the descriptions for FIGS. 5a-d).

Some of these layers are described in greater detail below.

Substrate 108:

The substrate 108 can be any material, which can support the layers on it. The substrate 108 is substantially transparent. The substrate 108 can be comprised of materials such as, for example, glass, quartz, silicon, or plastic; preferably, the substrate 108 is comprised of thin, flexible glass. The preferred thickness of the substrate 108 depends on the material used and on the application of the device. The substrate 108 can be in the form of a sheet or continuous film. The continuous film is used, for example, for roll-to-roll manufacturing processes which are particularly suited for plastic, metal, and metallized plastic foils.

Multi-Layer Mirror 111:

The multi-layer mirror 111 includes layers of substantially non-absorbing materials of appropriately chosen thickness. In one configuration, the layers of the mirror 111 are alternating pairs of high index and low index thin-films. In another configuration, the mirror 111 is comprised of alternating layers of high index and low index thins films and the mirror 111 has an odd number of layers. The reflectivity of the mirror 111 depends, in part, on the number of layers and the refractive index (“n”) of the materials used. The alternating layers can be, for example: SiO₂ (n=1.5) and TiO₂ (n=2.45); SiO₂ and SiₓN_{y;} and SiO₂ and SiN_{x.} The multi-layer mirror 111 can be, for example, the DBR stack or a quarter wave stack (“QWS”).

First Electrode 114:

The first electrode 114 is substantially transparent. In one configuration of this embodiment, the first electrode 114 functions as an anode (the anode is a conductive layer which serves as a hole-injecting layer and which comprises a material with work function greater than about 4.5 eV). Typical anode materials include metals (such as platinum, gold, palladium, indium, and the like); metal oxides (such as lead oxide, tin oxide, indium tin oxide (“ITO”), and the like); graphite; doped inorganic semiconductors (such as silicon, germanium, gallium arsenide, and the like); and doped conducting polymers (such as polyaniline, polypyrrole, polythiophene, and the like).

In an alternative configuration, the first electrode layer 311 functions as a cathode (the cathode is a conductive layer which serves as an electron-injecting layer and which comprises a material with a low work function). Typical cathode materials are listed below in the section for the “second electrode 123”.

The thickness of the first electrode 114 is from about 10 nm to about 1000 nm, preferably, from about 50 nm to about 200 nm, and more preferably, is about 100 nm.

The first electrode layer 114 can typically be fabricated using any of the techniques known in the art for deposition of thin films, including, for example, vacuum evaporation, sputtering, electron beam deposition, or chemical vapor deposition.

HTL 117:

The HTL 117 has a much higher hole mobility than electron mobility and is used to effectively transport holes from the anode. The HTL 117 can be comprised of small molecules or polymers. Examples of suitable small molecule materials are the aromatic amines, diphenyl diamines (“TPD”), or N,N′-di(naphthalene-1-yl)-N,N′-diphenyl-benzidine (“NPB”). Examples of suitable polymers are PEDOT:PSS or polyaniline (“PANI”).

The HTL 117 functions as: (1) a buffer to provide a good bond to the substrate 108; and/or (2) a hole injection layer to promote hole injection; and/or (3) a hole transport layer to promote hole transport.

The HTL 117 can be deposited using selective deposition techniques or nonselective deposition techniques. Examples of selective deposition techniques include, for example, ink-jet printing, flex printing, and screen printing. Examples of nonselective deposition techniques include, for example, spin coating, dip coating, web coating, and spray coating.

Emissive Layer 120:

The emissive layer 120 is comprised of an organic electroluminescent material. In one embodiment of the invention, the organic electroluminescent material has an emission spectrum with no luminance components with significant intensity at wavelengths shorter than the shortest wavelength at which a color change begins to occur. A color change occurs when the hue changes. The hue change, as used herein, refers to an intermediate change in color such as, for example, a change from deep green at 540 nm to a blue-green at 500 nm. The emission intensity is considered insignificant if, for example, it is less than 5% of the material's peak emission intensity.

When the microcavity is used in the OLED display, the amplified wavelength (i.e., the resonant wavelength) varies as a function of the viewing angle. However, since the wavelengths shorter than the wavelength at which the color change begins to occur have insignificant intensity, there won't be a perceived color change at different viewing angles. In the embodiment of the microcavity OLED device, the device emits the same color regardless of the viewing angle.

Preferably, the emissive material has an emission spectrum with no luminance components with significant intensity at wavelengths shorter than a resonant optical length of the microcavity at 0° viewing angle minus 20 nm. The “resonant optical length of the microcavity at 0° viewing angle” is the wavelength that is most amplified by the microcavity at the 0° viewing angle. The intensity at the shorter wavelengths can be, for example, less than 5% of the material's peak intensity. Simulations have shown that emissive materials with luminance components with insignificant intensity at wavelengths shorter than the resonant wavelength at the 0° viewing angle minus 20 nm have emission spectrums that do not have a noticeable color change at different viewing angles (e.g., refer to the descriptions for FIGS. 5a-d).

The emission spectrum output by the electroluminescent material can have either a normal intensity distribution (e.g., the peak emitted wavelength is at the center of the spectrum and the shorter wavelength side and the longer wavelength side are symmetrical and both sides have a sharp intensity drop-off), or it can have a sharp intensity drop-off only at the shorter wavelength side of the emission spectrum. Preferably, the emission spectrum at the longer wavelength side is wide and has a long tail, and the sharp intensity drop-off is only at the shorter wavelength side of the spectrum. The sharp intensity drop-off is near the wavelength at which a color change begins to occur. Preferably, the sharp intensity drop-off is near the resonant wavelength at 0° viewing angle minus 20 nm.

Optionally, the emission spectrum can be a narrow asymmetrical or symmetrical emission spectrum. For example, the narrow emission spectrum can have a small half-width; e.g., the half-width of the narrow emission spectrum can be 75 nm or less. The half-width is the width at which the maximum peak becomes half. The narrow emission spectrum, for example, can have insignificant intensity at wavelengths shorter than the resonant wavelength at the 0° viewing angle minus 20 nm and also at wavelengths longer than the resonant wavelength at the 0° viewing angle plus 20 nm.

Materials having the characteristics described above (e.g., materials that have insignificant intensity at wavelengths shorter than the desired wavelength, and also having the desired emission spectrum shape) can be obtained by, for example: (1) doping; (2) material synthesis; and (3) by surveying the emission spectrum of available emissive materials.

The organic electroluminescent material can be comprised of organic polymers or organic small molecules. Preferably, the electroluminescent material is fully or partially conjugated polymers.

The thickness of the emissive layer 120 is preferably from about 5 nm to about 500 nm, and more preferably, from about 20 nm to about 100 nm.

The emissive layer 120 can be deposited using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating.

Second Electrode 123:

The second electrode 123 is substantially reflective and acts as a mirror. The multi-layer mirror 111 and the cathode 123 together form the microcavity.

In one configuration of this embodiment, the second electrode 123 functions as a cathode. The cathode is typically a multilayer structure that includes, for example, a thin charge injection layer and a thick conductive layer. The charge injection layer has a lower work function than the conductive layer. The charge injection layer can be comprised of, for example, calcium or barium or mixtures thereof. The conductive layer can be comprised of, for example, aluminum, silver, magnesium, or mixtures thereof.

In an alternative configuration, the second electrode 123 functions as an anode. Typical anode materials are listed earlier in the section for the “first electrode 114”.

The thickness of the second electrode 123 is from about 10 nm to about 1000 nm, preferably from about 50 nm to about 500 nm, and more preferably, from about 100 nm to about 300 nm.

The second electrode 123 can typically be fabricated using any of the techniques known in the art for deposition of thin films, including, for example, vacuum evaporation, sputtering, electron beam deposition, or chemical vapor deposition.

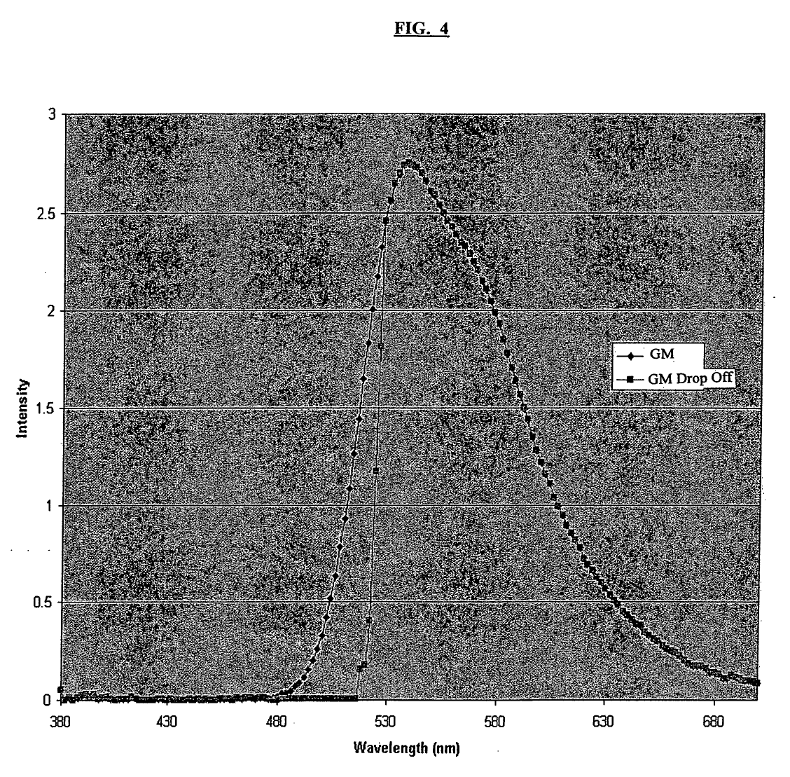

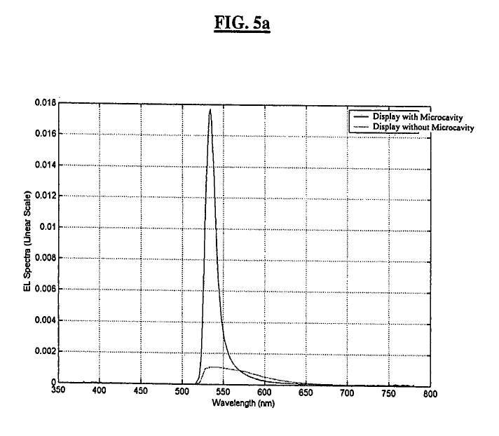

FIG. 4 shows simulated emission spectrums of the emissive layer comprised of green emitting material without a sharp intensity drop-off (“GM”) and a green emitting material with a sharp intensity drop-off (“GM-DROP-OFF”). In FIG. 4, the wavelength is specified in nanometers and the intensity has arbitrary units. The emission spectrum of the GM at the shorter wavelength side from the peak has a wider spectrum and a longer tail than the shorter wavelength side of the GM-DROP-OFF's emission spectrum. The emission spectrum of the GM-DROP-OFF has a sharp intensity drop-off near 520 nm. As shown in FIG. 4, for the GM-DROP-OFF's emission spectrum, the intensity of the luminance components at wavelengths shorter than approximately 520 nm is less than 5% of a peak intensity emitted by the material.

FIGS. 5a-d show simulated emission spectrums at various viewing angles for OLED displays with and without a microcavity where the emissive layer is made of the GM-DROP-OFF. In FIG. 5a, the OLED with the microcavity has a peak emitted wavelength of about 533 nm at the viewing angle of 0°.

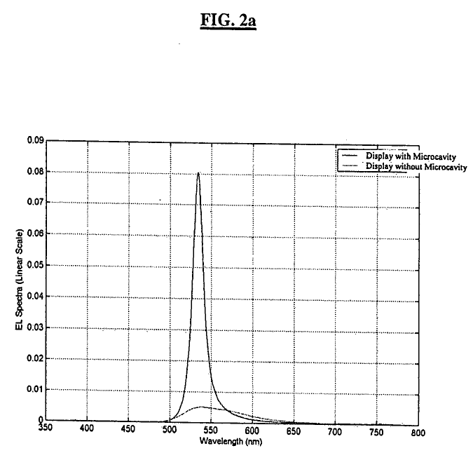

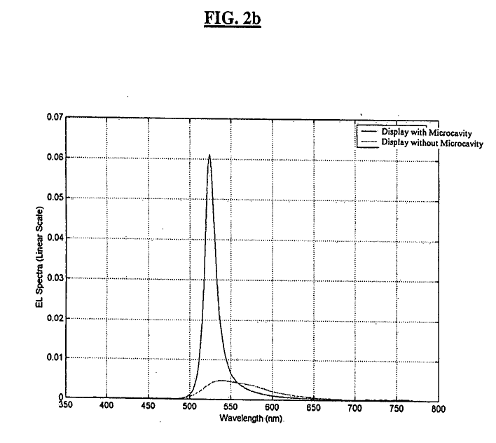

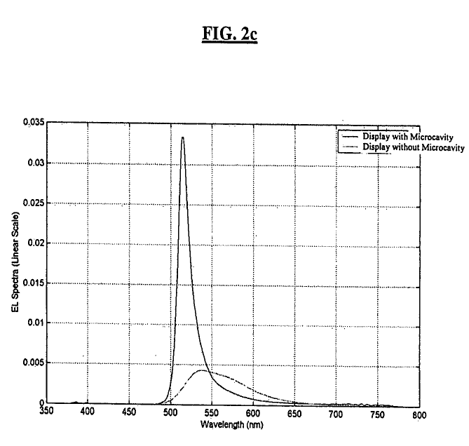

In FIG. 5b, at the viewing angle of 21.06°, the OLED with the microcavity has a peak emitted wavelength of approximately 528 nm; in this case, there is a slight blue shift of 5 nm from the peak emitted wavelength at the viewing angle of 0°. Comparing FIG. 2b with FIG. 5b, at the viewing angle of 21.06°, the GM (i.e., the green emitting material without the sharp intensity drop-off as shown in FIG. 2b) has a blue shift of about 15 nm while the GM-DROP-OFF has the blue shift of only about 5 nm. At this viewing angle, the peak emitted wavelength of the GM-DROP-OFF has a lower intensity (i.e., electroluminance) than the peak emitted wavelength of the GM-DROP-OFF at the viewing angle of 0° (i.e., for the display with the microcavity, at the viewing angle of 0°, the peak emitted wavelength has an intensity of approximately 0.01775 while at the viewing angle of 21.06°, the peak emitted wavelength has an intensity of approximately 0.011).

In FIG. 5c, at the viewing angle of 30.35°, the OLED with the microcavity has a peak emitted wavelength of approximately 528 nm; here, as in FIG. 5b, there is only a slight blue shift of 5 nm from the peak emitted wavelength at the viewing angle of 0°. Comparing FIG. 2c with FIG. 5c, at the viewing angle of 30.35°, the GM has a blue shift of about 25 nm while the GM-DROP-OFF has the blue shift of only about 5 nm. At this viewing angle, the peak emitted wavelength of the GM-DROP-OFF has a lower intensity than the peak emitted wavelength of the GM-DROP-OFF at the viewing angle of 0° (i.e., for the display with the microcavity, at the viewing angle of 30.050, the peak emitted wavelength has an intensity of approximately 0.0029).

In FIG. 5d, at the viewing angle of 40.34°, the OLED with the microcavity has a peak emitted wavelength of approximately 528 nm; here, as in FIGS. 5b-c, there is only the slight blue shift of 5 nm from the peak emitted wavelength at the viewing angle of 0°. Comparing FIG. 2d with FIG. 5d, at the viewing angle of 40.34°, the GM has a blue shift of about 40 nm while the GM-DROP-OFF has the blue shift of only about 5 nm. At this viewing angle, the peak emitted wavelength of the GM-DROP-OFF has a lower intensity than the peak emitted wavelength of the GM-DROP-OFF at the viewing angle of 0° (i.e., for the display with the microcavity, at the viewing angle of 40.34°, the peak emitted wavelength has an intensity of approximately 0.0009).

As shown in FIGS. 5b-d, for the GM-DROP-OFF, as the viewing angle increases, there is minimal blue-shifting of the peak emitted wavelength so there is no perceived color change at the different viewing angles. The peak emitted wavelength from the microcavity at any viewing angle is close to the peak emitted wavelength from the microcavity at the 0° viewing angle. At the higher viewing angles (e.g., at 40.34°), the microcavity is amplifying the portion of the emissive layer's emission spectrum having the insignificant intensity. Thus, the emitted light has a lower intensity since the microcavity is amplifying the shorter wavelengths with the original insignificant intensity and even though the original intensity is amplified, the resulting amplified intensity remains insignificant.

In FIG. 5a, the resonant wavelength (i.e., the wavelength most amplified by the microcavity is approximately 533 nm which is the peak emitted wavelength of the GM-DROP-OFF without the microcavity. However, in another configuration, if the emission spectrum of the emissive material is wide on the longer wavelength side from the peak, the microcavity can be designed so that the resonant wavelength at 0° is a wavelength on the longer wavelength side from the peak whose intensity is on the shoulder of the emission spectrum. For example, in FIG. 5a, rather than 533 nm, the microcavity can be designed to have a resonant wavelength that is on the shoulder of the emission spectrum at, for example, 540 nm. By having the resonant wavelength on the shoulder, the blue-shift in the resonant wavelength occurring at viewing angles away from 0° can result in the resonant wavelength being the peak wavelength of the material. By doing this, the intensity of the emitted light is maximized at viewing angles away from 0° while not significantly decreasing the intensity of the light emitted at the 0° viewing angle.

The intensity of the light emitted by the microcavity at the viewing angle of 0° when the emissive material is GM-DROP-OFF is approximately equal to the intensity of the light emitted by the microcavity at the same angle when GM is used as the emissive material.

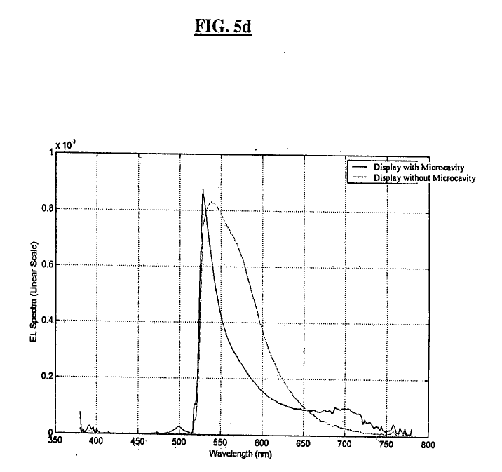

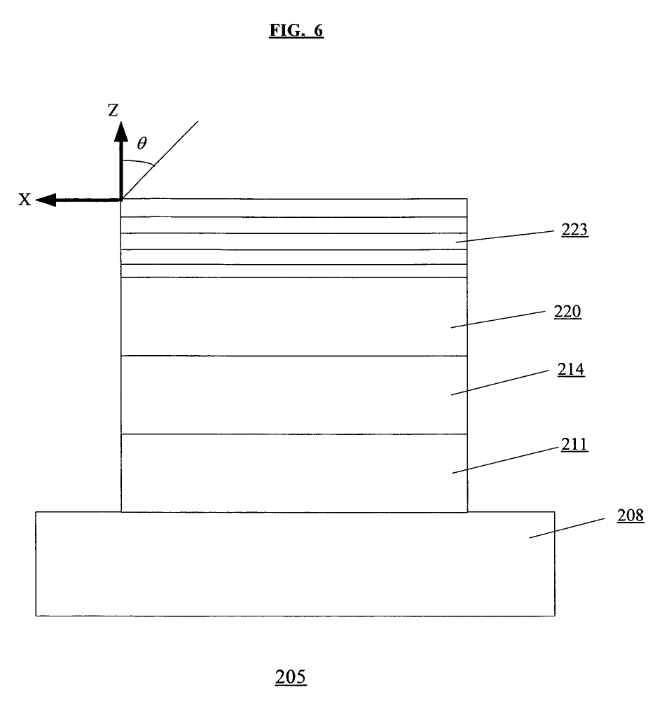

Alternatively, rather than emitting light from the bottom, the microcavity OLED device can emit light from the top of the device. FIG. 6 shows a cross-sectional view of a second embodiment of a microcavity OLED device 205 according to the present invention. The OLED device 205 is a top-emitting device. In FIG. 6, a first electrode 211 is on a substrate 208. The first electrode 211 is substantially reflective and functions as a mirror. The substrate 208 can be either substantially transparent or substantially reflective. The emissive layer 214 is on the first electrode 211. A second electrode 220 is on the emissive layer 214. The second electrode 220 is substantially transparent. A multi-layer mirror 223 is on the second electrode 220. The multi-layer mirror 223 and the first electrode 211 together form the microcavity. The viewing angle (“θ”) represents an angle from the z-axis; this axis is normal to the multi-layer mirror 223.

The OLED devices described earlier can be used in applications such as, for example, computer displays, information displays in vehicles, television monitors, telephones, printers, illuminated signs, or applications where color change is undesirable and directionality is desired.

As any person of ordinary skill in the art of electronic device fabrication will recognize from the description, figures, and examples that modifications and changes can be made to the embodiments of the invention without departing from the scope of the invention defined by the following claims.

What is claimed:

1. A microcavity OLED device that minimizes or eliminates color change at different viewing angles, comprising:
a substrate;
a multi-layer mirror on said substrate, wherein said multi-layer mirror is comprised of a plurality of layers, each of said plurality of layers is comprised of a non-absorbing material;
a first electrode on said multi-layered first mirror, wherein said first electrode is substantially transparent;
an emissive layer on said first electrode; and
a second electrode on said emissive layer, wherein said second electrode is a mirror,
wherein said multi-layer mirror and said second electrode form a microcavity that amplifies a particular wavelength that is in resonance with an optical length of said microcavity, and
wherein said emissive layer is comprised of a material that has an emission spectrum with no luminance components with significant intensity at wavelengths shorter than a wavelength at which a color change begins to occur.

2. The OLED device of claim 1 wherein said material has an emission spectrum with no luminance components with significant intensity at wavelengths shorter than a resonant optical length of said microcavity at 0° viewing angle minus 20 nm.

3. The OLED device of claim 2 wherein said emission spectrum is asymmetrical and has a sharp intensity drop-off on a shorter wavelength side from a peak emitted wavelength, and said peak emitted wavelength is at a desired color.

4. The OLED device of claim 2 wherein said emission spectrum is a narrow emission spectrum.

5. The OLED device of claim 1 wherein at a large viewing angle where said microcavity is amplifying a shorter wavelength with insignificant intensity, a peak emitted wavelength at said large viewing angle is close to a peak emitted wavelength from said microcavity at said 0° viewing angle.

6. The OLED device of claim 1 wherein at a large viewing angle where said microcavity is amplifying a shorter wavelength with insignificant intensity, said resonant wavelength is different than a peak emitted wavelength from said microcavity at said large viewing angle.

7. The OLED device of claim 1 wherein said color change begins to occur when a wavelength emits a different hue than that of said peak emitted wavelength from said microcavity at a 0° viewing angle.

8. The OLED device of claim 2 wherein said intensity of said luminance components at wavelengths shorter than said resonant optical length of said microcavity at 0° viewing angle minus 20 nm is less than 5% of an intensity of a peak emitted wavelength of said material.

9. The OLED device of claim 1 wherein a peak emitted wavelength from said microcavity at any viewing angle is close to a peak emitted wavelength of said material.

10. The OLED device of claim 1 wherein adjacent layers of said multi-layer mirror have different refractive indexes.

11. The OLED device of claim 1 wherein a particular one of said adjacent layers has a high refractive index and another one of said adjacent layers has a low refractive index.

12. The OLED device of claim 1 wherein said first electrode is an anode, and further comprising a hole transport layer on said anode, wherein said hole transport layer is between said anode and said emissive layer.

13. The OLED device of claim 1 wherein said OLED device is an OLED display or an OLED light source used for area illumination.

14. A method to fabricate a microcavity OLED device that minimizes or eliminates color change at different viewing angles, comprising:
forming a multi-layer mirror on a substrate, wherein said multi-layer mirror is comprised of a plurality of layers, each of said plurality of layers is comprised of a non-absorbing material;
forming a first electrode on said multi-layer mirror, wherein said first electrode is substantially transparent;
forming an emissive layer on said first electrode; and
forming a second electrode on said emissive layer, wherein said second electrode is a mirror,
wherein said multi-layer mirror and said second electrode form a microcavity that amplifies a particular wavelength that is in resonance with an optical length of said microcavity, and
wherein said emissive layer is comprised of a material that has an emission spectrum with no luminance components with significant intensity at wavelengths shorter than a wavelength at which a color change begins to occur.

15. The method of claim 14 wherein said material has an emission spectrum with no luminance components with significant intensity at wavelengths shorter than a resonant optical length of said microcavity at 0° viewing angle minus 20 nm.

16. The method of claim 15 wherein said emission spectrum is asymmetrical and has a sharp intensity drop-off on a shorter wavelength side from a peak emitted wavelength, and said peak emitted wavelength is at a desired color.

17. The method of claim 15 wherein said emission spectrum is a narrow emission spectrum.

18. The method of claim 14 wherein said color change begins to occur when a wavelength emits a different hue than that of said peak emitted wavelength.

19. The method of claim 15 wherein said intensity of said luminance components at wavelengths shorter than said resonant optical length of said microcavity at 0° viewing angle minus 20 nm is less than 5% of an intensity of a peak emitted wavelength of said material.

20. The method of claim 14 wherein adjacent layers of said multi-layer mirror have different refractive indexes.

21. The method of claim 14 wherein said first electrode is an anode, and further comprising forming a hole transport layer on said anode, wherein said hole transport layer is between said anode and said emissive layer.

22. A top-emitting microcavity OLED device that minimizes or eliminates color change at different viewing angles, comprising:
a substrate;
a first electrode on said substrate, wherein said first electrode is a mirror;
an emissive layer on said first electrode; and
a second electrode on said emissive layer, wherein said second electrode is substantially transparent; and
a multi-layer mirror on said second electrode, wherein said multi-layer mirror is comprised of a plurality of layers, each of said plurality of layers is comprised of a non-absorbing material,
wherein said first electrode and said multi-layer mirror form a microcavity that amplifies a particular wavelength that is in resonance with an optical length of said microcavity, and
wherein said emissive layer is comprised of a material that has an emission spectrum with no luminance components with significant intensity at wavelengths shorter than a wavelength at which a color change begins to occur.

23. The OLED device of claim 22 wherein said material has an emission spectrum with no luminance components with significant intensity at wavelengths shorter than a resonant optical length of said microcavity at 0° viewing angle minus 20 nm.

24. The OLED device of claim 22 wherein at a large viewing angle where said microcavity is amplifying a shorter wavelength with insignificant intensity, a peak emitted wavelength at said large viewing angle is close to a peak emitted wavelength from said microcavity at said 0° viewing angle.

25. The OLED device of claim 22 wherein at a large viewing angle where said microcavity is amplifying a shorter wavelength with insignificant intensity, said resonant wavelength is different than a peak emitted wavelength from said microcavity at said large viewing angle.

26. The OLED device of claim 22 wherein said color change begins to occur when a wavelength emits a different hue than that of said peak emitted wavelength from said microcavity at a 0° viewing angle.

27. The OLED device of claim 23 wherein said intensity of said luminance components at wavelengths shorter than said resonant optical length of said microcavity at 0° viewing angle minus 20 nm is less than 5% of an intensity of a peak emitted wavelength of said material.

28. A method to minimize or eliminate color change in the light emitted from a microcavity OLED device at a large viewing angle, said device includes a microcavity and an emissive layer, said method comprising:
if a resonant wavelength at said large viewing angle is a wavelength shorter than a resonant optical length of said microcavity at 0° viewing angle minus 20 nm, then amplifying, using said microcavity, insignificant emission intensities of said emissive layer; and
if said resonant wavelength at said large viewing angle is a wavelength longer than a resonant optical length of said microcavity at 0° viewing angle minus 20 nm, then amplifying, using said microcavity, significant emission intensities of said emissive layer.

29. The method of claim 28 wherein said insignificant emission intensity is an intensity that is less than 5% of an emission intensity of a peak emitted wavelength of said emissive layer.
